(19) United States
(12) Patent Application Publication
(10) Pub. No.: US 2009/0064640 A1
(43) Pub. Date: Mar. 12, 2009

(54) SADDLE FOR STEER WRESTLING

(76) Inventor: Dennis George, Riverton, WY (US)

Correspondence Address: DAVIS, BROWN, KOEHN, SHORS & ROBERTS, P.C.;THE DAVIS BROWN TOWER, 215 10TH STREET SUITE 1300, DES MOINES, IA, 50309, US

(21) Appl. No.: 12/209,264

(22) Filed: Sep. 12, 2008

Related U.S. Application Data
(60) Provisional application No. 60/993,441, filed on Sep. 12, 2007.

(51) Int. Cl. B68C 1/02

(52) U.S. Cl. 54/44.1

(57) ABSTRACT

A saddle specially adapted for steer wrestling is disclosed. Instead of having a symmetrical cantle having a central point and two cupped side sections, the present invention has a cantle with a straight portion to the dismount side of the saddle to enable a smooth and fast dismount of the steer wrestling competitor.

### BACKGROUND OF THE INVENTION

This application claims priority to U.S. patent application No. 60/993,441, filed Sep. 12, 2007.

The invention relates generally to saddle trees and, more specifically, to saddle trees for steer wrestling.

In conventional saddles, the back of the saddle, or cantle, is shaped to support the lower back and buttocks of a rider. The cantle includes a central point and two cupped sections on either side of the central point. The cupped sections help hold the rider in the saddle.

In the sport of steer wrestling, a rider and horse race after a steer. The steer wrestler slides from the back of the horse onto the neck and back of the steer, wrestles the steer to the ground, and when all four legs are off the ground, an official waves a flag and a time is given. The competition is timed and the rider with the fastest time wins. Cantles of conventional saddles inhibit smooth and fast dismounting of the rider. There is a need for a steer wrestling saddle that permits smooth and fast dismounting of a rider.

### SUMMARY OF THE INVENTION

The invention is a saddle that has a modified cantle to permit smooth and fast dismounting of a rider. The cantle has been shaped to straighten the side of the saddle to which the rider dismounts. By removing the cup-shape of the cantle on the dismount or right side, the rider can slide smoothly and with a quick dismount from the saddle.

### BRIEF DESCRIPTION OF THE DRAWINGS

FIG. 1 is a perspective view of a saddle of the present invention.

FIG. 2 is a top view of a saddle tree that forms an interior structure of the saddle of FIG. 1.

FIG. 2 is a top view of the cantle of the saddle of FIG. 1.

### DETAILED DESCRIPTION OF A PREFERRED EMBODIMENT

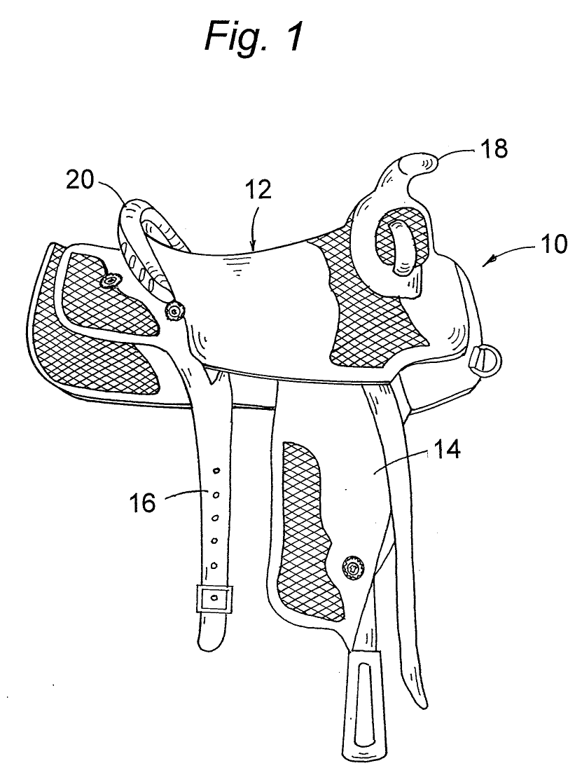

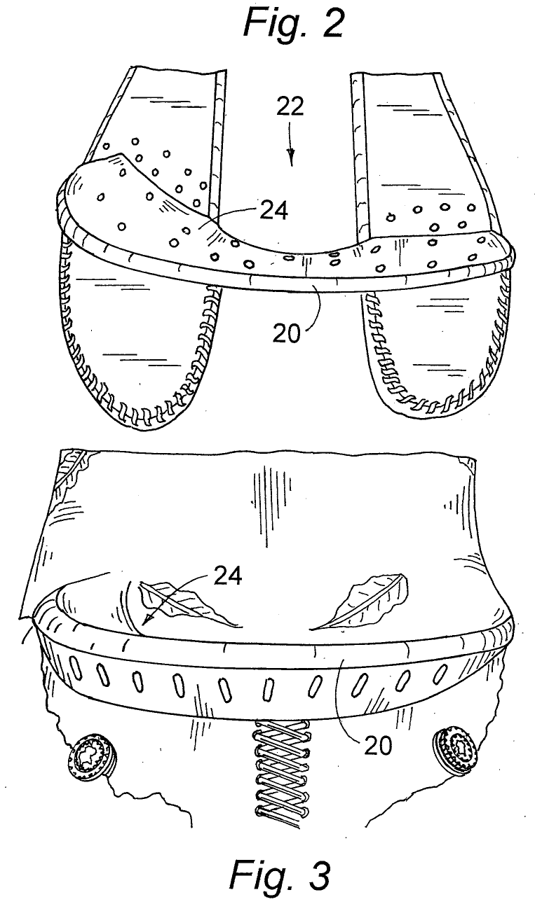

Illustrated in FIG. 1, generally at 10, is a saddle of the present invention. It is of a type generally known as a Western saddle and more specifically as a steer wrestling saddle. It includes a seat 12, a pair of stirrup leathers and stirrups 14, and a back billet and cinch 16. The seat 12 includes a horn 18 and a cantle 20. The seat 12 is formed, at least in part, by a saddle tree 22 (FIG. 2) which is often made of wood and covered with rawhide. The conventional saddle tree is symmetrical about the longitudinal centerline, having a central point and two cup-shaped sections on either side of the point. In preferred embodiments of the present invention, the saddle tree 22 is asymmetrical, lacking one of the cupped sections. In the preferred embodiment of the saddle tree 22, the cupped section on the right side of the saddle 10 has been removed by making the saddle tree 22 straight across on the right side so that only the cupped section 24 remains.

As best illustrated in FIG. 3, the asymmetrical shape of the saddle tree 22 gives an asymmetrical shape to the cantle 20. The cantle 20 still has a cupped section 24 on the left hand side of the saddle 10, but is straight across on the right hand side. This enables a smooth and fast dismount of the rider to the right hand side of the horse and should improve the rider's time in a steer wrestling competition. While the preferred embodiment has been described as having a right hand dismount side, the saddle could of course be adapted to have a left hand dismount side. Another advantage of the present invention is safety. The asymmetrical saddle 10 allows the cowboy's body to reach the steer at the same time as the cowboy's arm. If a steer sets up or stops, the right shoulder is not dislocated because the steer's left horn is stopped from sliding past the steer wrestler's hip, thus stopping the dislocating defect on the shoulder when the arm is pulled back as the steer stops.

The foregoing description and drawings comprise illustrative embodiments of the present inventions. The foregoing embodiments and the methods described herein may vary based on the ability, experience, and preference of those skilled in the art. Merely listing the steps of the method in a certain order does not constitute any limitation on the order of the steps of the method. The foregoing description and drawings merely explain and illustrate the invention, and the invention is not limited thereto, except insofar as the claims are so limited. Those skilled in the art that have the disclosure before them will be able to make modifications and variations therein without departing from the scope of the invention.

1. A steer wrestling saddle, comprising an asymmetric cantle.

2. A saddle as defined in claim 1, wherein the cantle has only a single cup-shaped side section.

3. A saddle as defined in claim 1, wherein the cantle has a straight section that extends to the side of the saddle.
